(19) United States
(12) Patent Application Publication
(10) Pub. No.: US 2024/0309237 A1
(43) Pub. Date: Sep. 19, 2024

(54) POWDER COATING COMPOSITION, COATING FILM, FLUORORESIN LAMINATE, AND ARTICLE

(71) Applicant: DAIKIN INDUSTRIES, LTD., Osaka (JP)

(72) Inventors: Hirotake IMADA, Osaka (JP); Yukari HONDA, Osaka (JP); Toshio MIYATANI, Osaka (JP); Yasukazu NAKATANI, Osaka (JP)

(73) Assignee: DAIKIN INDUSTRIES, LTD., Osaka (JP)

(21) Appl. No.: 18/673,507

(22) Filed: May 24, 2024

Related U.S. Application Data
(63) Continuation of application No. PCT/JP2022/042396, filed on Nov. 15, 2022.

(30) Foreign Application Priority Data
Nov. 26, 2021 (JP) 2021-191912

(51) Int. Cl. C09D 127/18; C09D 5/03; C09D 5/16

(52) U.S. Cl. CPC C09D 127/18; C09D 5/031; C09D 5/1668

(57) ABSTRACT

A powder coating composition for a primer for a fluororesin layer and providing strong adhesion. The composition including an amide group-containable polymer compound (A), polyphenylene sulfide (B), and perfluorinated fluororesin (C), where the polymer compound (A) is an amide group-containing polymer (a1) having an amide group and an aromatic ring and/or an amide group-containing polymer precursor (a2) that changes to the amide group-containing polymer (a1) during sintering when forming the composition into a film, a content of the polyphenylene sulfide (B) is 1-50 mass % of a total of the polymer compound (A) and the polyphenylene sulfide (B), the perfluorinated fluororesin (C) includes tetrafluoroethylene in a range of 85.0-99.5 mol % and has a MFR in a range of 5-30 (g/10 min), and a content of the perfluorinated fluororesin (C) is 50.0-95.0 mass % of a total of the polymer compound (A), the polyphenylene sulfide (B), and the perfluorinated fluororesin (C).

### CROSS REFERENCE TO RELATED APPLICATIONS

This application is a Rule 53 (b) Continuation of International Application No. PCT/JP2022/042396 filed Nov. 15, 2022, claiming priority based on Japanese Patent Application No. 2021-191912 filed Nov. 26, 2021, the respective disclosures of which are incorporated herein by reference in their entirety.

### TECHNICAL FIELD

The present disclosure relates to a powder coating material composition, a coating film, a fluorine-containing resin laminate, and an article.

### BACKGROUND ART

Fluororesins have a broad range of applications by being prepared into coating material compositions and applied to the substrates of baking molds, rice cookers, and the like that require, for example, corrosion resistance, non-stickinesss, and heat resistance to form a fluororesin layer. However, due to the non-stickiness thereof, fluororesins have poor adhesion to substrates made of metals, ceramics, and the like, and, accordingly, a primer that has affinity for both a fluororesin and a substrate is applied to the substrates.

Research has been carried out into combinations of fluororesins and various binder resins as primers having excellent heat-resisting adhesion. The use of polyphenylene sulfide (PPS) as a binder resin has been proposed from the viewpoint of heat resistance. However, PPS is problematic by having poor compatibility with fluororesins and thus insufficient adhesion to the fluororesin layer.

Patent Literature 1 discloses a resin composition that is a powder coating material, wherein the resin composition comprises an amide group-containable polymer compound (A) that has an amide group or will have an amide group, polyarylene sulfide, and a fluororesin in specific amounts.

Patent Literature 2 discloses a laminate comprising a primer layer (1) obtained from a primer composition and a fluororesin layer (2) composed of a fluorinated perfluoropolymer (D) and formed on the primer layer (1), wherein the primer composition comprises an amide group-containable polymer compound (A) that has an amide group or will have an amide group, an antioxidative material (B) capable of suppressing the oxidation of the amide group, and a fluororesin (C).

### CITATION LIST

### Patent Literature

Patent Literature 1
Japanese Patent Laid-Open No. 2010-43283
Patent Literature 2
Japanese Patent Laid-Open No. 2005-335185

### SUMMARY

The present disclosure relates to a powder coating material composition comprising an amide group-containable polymer compound (A) that has an amide group or will have an amide group, polyphenylene sulfide (B), and a perfluorinated fluororesin (C), wherein
the amide group-containable polymer compound (A) is an amide group-containing polymer (a1) having an amide group and an aromatic ring and/or an amide group-containing polymer precursor (a2) that changes to the amide group-containing polymer (a1) in a sintering step when forming the powder coating material composition into a film,
a content of the polyphenylene sulfide (B) is 1 to 50% by mass of a total of the amide group-containable polymer compound (A) and the polyphenylene sulfide (B),
the perfluorinated fluororesin (C) comprises tetrafluoroethylene in a range of 85.0 to 99.5 mol % and has a melt flow rate (MFR) in a range of 5 to 30 (g/10 min), and
a content of the perfluorinated fluororesin (C) is 50.0 to 95.0% by mass of a total of the amide group-containable polymer compound (A), the polyphenylene sulfide (B), and the perfluorinated fluororesin (C).

### Advantageous Effects of Invention

With the powder coating material composition of the present disclosure, a coating film having excellent adhesion to a metal substrate can be obtained. Also, by using the powder coating material composition as a primer coating material, a primer layer having excellent adhesion to a fluororesin layer can be formed.

### DESCRIPTION OF EMBODIMENTS

Below, the present disclosure will now be described in detail.

The present disclosure provides a powder coating material composition comprising an amide group-containable polymer compound (A) that has an amide group or will have an amide group, polyphenylene sulfide (B), and a perfluorinated fluororesin (C), wherein
the amide group-containable polymer compound (A) is an amide group-containing polymer (a1) having an amide group and an aromatic ring and/or an amide group-containing polymer precursor (a2) that changes to the amide group-containing polymer (a1) in a sintering step when forming the powder coating material composition into a film,
a content of the polyphenylene sulfide (B) is 1 to 50% by mass of a total of the amide group-containable polymer compound (A) and the polyphenylene sulfide (B),
the perfluorinated fluororesin (C) comprises tetrafluoroethylene in a range of 85.0 to 99.5 mol % and has a MFR in a range of 5 to 30 (g/10 min), and
a content of the perfluorinated fluororesin (C) is 50.0 to 95.0% by mass of a total of the amide group-containable polymer compound (A), the polyphenylene sulfide (B), and the perfluorinated fluororesin (C).

The powder coating material composition of the present disclosure contains in specific amounts the amide group-containable polymer compound (A), the polyphenylene sulfide (B), and the perfluorinated fluororesin (C) having an MFR in a specific range, and is thus capable of forming a coating film that has excellent adhesion to a coating target and also has improved adhesion to a fluororesin layer.

The powder coating material composition of the present disclosure contains an amide group-containable polymer compound (A) that has an amide group or will have an amide group and polyphenylene sulfide (B) capable of suppressing the oxidation of the amide group.

The powder coating material composition of the present disclosure provides a coating film by being applied to a coating target. Herein, the term “applying” means a series of steps including applying the coating material composition to a subject of coating such as a coating target, optionally drying the coating material composition, and then sintering the coating material composition. Sintering is heating the coating material composition at a temperature equal to or higher than the melting points of principal polymer components in the powder coating material composition of the present disclosure. The sintering temperature varies according to the melting points of the amide group-containable polymer compound (A), the polyphenylene sulfide (B), and the perfluorinated fluororesin (C) described below.

The amide group-containable polymer compound (A) is an amide group-containing polymer (a1) having an amide group and an aromatic ring and/or an amide group-containing polymer precursor (a2) that changes to the amide group-containing polymer (a1) by sintering when the powder coating material composition is applied.

The amide group-containing polymer (a1) is usually a polymer having an amide group (—NH—C(═O)—) in its main chain or side chain and an aromatic ring in its main chain. The amide group-containing polymer (a1) is preferably polyamideimide [PAI], polyamide, and/or polyamide acid (polyamic acid).

PAI is a polycondensate having an amide group, an aromatic ring, and an imide group. PAI is not limited and, in addition to conventionally known PAI, for example, what is obtained by introducing an amide group by oxidizing polyimide [PI] can be used.

Polyamide is a polycondensate having an amide bond (—NH—C(═O)—) in its main chain. Polyamide is not limited, and examples includes aliphatic polyamides such as nylon 6, nylon 66, nylon 11, and nylon 12; and aromatic polyamides such as polyparaphenylene terephthalamide and polymetaphenylene isophthalamide.

Polyamide acid is a polycondensate having an amide group as well as a carboxyl group or a derivative of a carboxyl group. Polyamide acid is not limited, and examples include polyamide acids having a molecular weight of several thousands to several tens of thousands.

The amide group-containing polymer precursor (a2) changes to the amide group-containing polymer (a1) by sintering when the powder coating material composition of the present disclosure is applied.

The phrase “sintering when the powder coating material composition is applied”, when the powder coating material composition of the present disclosure is used as a primer composition that will be described below and then an overcoating material is applied, corresponds to:
(1) “sintering” that is usually performed after the primer composition is applied and before the overcoating material is applied,
(2) “sintering” when the overcoating material is applied after the sintering of the above (1), or
(3) “sintering” when the overcoating material is applied without performing the sintering of the above (1), and
when using the powder coating material composition of the present disclosure in a one-coat method that will be described below, corresponds to:
(4) “sintering” after the powder coating material composition is applied, and it is a concept that may encompass any of (1) to (4).

The amide group-containing polymer precursor (a2), as described above, changes to the amide group-containing polymer (a1) by sintering when the powder coating material composition is applied. In this sintering, the aromatic ring contained in the amide group-containing polymer (a1) usually does not change, and thus the amide group-containing polymer precursor (a2) has an aromatic ring but does not have an amide group before applying and sintering the powder coating material composition of the present disclosure.

Herein, a polymer compound having an amide group and further having an aromatic ring before applying and sintering the powder coating material composition corresponds to the amide group-containing polymer (a1) described above.

The amide group-containing polymer precursor (a2) is not limited as long as it changes to the amide group-containing polymer (a1) by applying and sintering the powder coating material composition of the present disclosure, and an example may be PI or the like. An amide group can be introduced into the main chain of PI by application of the powder coating material composition of the present disclosure and oxidation during sintering at high temperatures for a long period of time. The amide group-containing polymer (a1) obtained by introducing an amide group into PI is PAI or polyamide acid. In order to be PAI, not all imide groups in the main chain of PI are converted to amide groups, and in order to be polyamide acid, all imide groups in the main chain of PI are converted to amide groups and carboxyl groups.

The method for introducing an amide group into PI is not limited, and examples include a method involving ring-opening the imide group (the imide ring) of PI by oxidation, and a method involving causing an alkali to act on and hydrolyze the imide group (the imide ring) of PI. Herein, a site on the molecular structure into which an amide group is to be introduced, e.g., an imide group that changes to an amide group by the above oxidation, may be referred to as an amide group introduction site.

The amide group-containing polymer compound (A) has or will have an amide group.

The phrase “will have an amide group” means that the amide group-containable polymer compound (A) does not necessarily have an amide group when adding the amide group-containable polymer compound (A) to prepare the powder coating material composition of the present disclosure, but undergoes a chemical change by sintering when the powder coating material composition is applied, and an amide group is introduced before this sintering is complete.

Herein, the phrase “has an amide group or will have an amide group” refers to a concept that may encompass any of having an amide group and not having an amide group introduction site, not having an amide group and having an amide group introduction site, and having an amide group and having an amide group introduction site, when adding the amide group-containable polymer compound (A) to prepare the powder coating material composition of the present disclosure. That is to say, the powder coating material composition of the present disclosure may contain both the amide group-containing polymer (a1) and the amide group-containing polymer precursor (a2), or may contain either one of (a1) and (a2).

The polyphenylene sulfide (B) is capable of suppressing the oxidation of the amide group.

It is presumed that the polyphenylene sulfide (B) is self-oxidized prior to the oxidation of the amide group, thereby retarding the oxidation of the amide group.

The content of the polyphenylene sulfide (B) is 1 to 50% by mass of the total of the amide group-containable polymer compound (A) and the polyphenylene sulfide (B). A content exceeding 50% by mass likely results in poor adhesion after hot water treatment, and a content of less than 1% by mass likely results in poor adhesion after heat treatment.

The powder coating material composition of the present disclosure contains the amide group-containable polymer compound (A), the polyphenylene sulfide (B), and, moreover, the perfluorinated fluororesin (C).

The powder coating material composition of the present disclosure, by being applied, can form a coating film having a two-layer structure including a first layer (a surface layer) containing the perfluorinated fluororesin (C) as a main component and a second layer containing the amide group-containable polymer compound (A) and the polyphenylene sulfide (B) as main components. The powder coating material composition of the present disclosure containing the perfluorinated fluororesin (C), when a fluororesin layer composed of a perfluorinated fluororesin (D) is stacked on the first layer, can form a coating film having excellent adhesion to the fluororesin layer due to compatibility between the perfluorinated fluororesin (C) in the first layer and the perfluorinated fluororesin (D).

The coating film having a two-layer structure is described herein as having “a two-layer structure” for convenience, but it is presumed that in reality the closer to the coating target, the higher the concentrations of the amide group-containable polymer compound (A) and the polyphenylene sulfide (B), and the further from the coating target, the higher the concentration of the perfluorinated fluororesin (C) instead of the polyphenylene sulfide (B), and the perfluorinated fluororesin (C) is present in a high concentration on the outermost surface of the coating film. Accordingly, the coating film depending on the amounts of the components may have a layer that should be referred to as a so-called intermediate layer composed of the amide group-containable polymer compound (A) and the perfluorinated fluororesin (C) between a layer composed of the perfluorinated fluororesin (C) and a layer composed of the amide group-containable polymer compound (A) and the polyphenylene sulfide (B).

As for the perfluorinated fluororesin (C), the temperature of sintering when the powder coating material composition of the present disclosure is applied is preferably 300° C. or higher.

The temperature of sintering during coating is generally a temperature equal to or higher than the melting point of the perfluorinated fluororesin (C). The sintering during coating may be the same as the “sintering when the coating material composition is applied” described above for the amide group-containing polymer precursor (a2).

The powder coating material composition of the present disclosure unlikely results in deterioration of adhesion to a coating target even after being sintered for a long period of time of several tens of hours at a temperature of 300° C. or higher. To date, such excellent heat-resisting adhesion has been achieved only by using a chromium-based primer, but the powder coating material composition of the present disclosure can provide excellent heat-resisting adhesion without using chromium or a chromium compound.

The perfluorinated fluororesin (C) is composed of a polymer obtained by polymerizing a fluorine-containing monomer.

The perfluorinated fluororesin (C) more preferably is a polymer having a melting point lower than the above sintering temperature during coating and having heat resistance at the sintering temperature.

The perfluorinated fluororesin (C) is preferable in terms of having both corrosion resistance and heat resistance.

The perfluorinated fluororesin is usually a resin that requires a sintering temperature of 300° C. or higher, and composed of a perfluorinated polymer obtained by polymerizing perfluoroolefin with perfluorovinyl ether and/or a trace comonomer. Perfluoroolefin is not limited, and examples include tetrafluoroethylene (TFE) and hexafluoropropylene (HFP). Perfluorovinyl ether is not limited, and examples include perfluoroalkyl vinyl ethers such as perfluoro (methyl vinyl ether), perfluoro (ethyl vinyl ether), and perfluoro (propyl vinyl ether).

The trace comonomer may be one or more of fluorine-containing monomers that are neither the above perfluoroolefin nor perfluorovinyl ether, and/or fluorine-free monomers. The repeating unit derived from the trace comonomer in the molecular chain of the perfluorinated polymer is preferably less than 10 mol % of all monomer units of the perfluorinated polymer.

In the present disclosure, the perfluorinated fluororesin (C) contains tetrafluoroethylene in a range of 85.0 to 99.5 mol %. Moreover, the perfluorinated fluororesin (C) is preferably a copolymer containing tetrafluoroethylene as well as perfluoroalkyl vinyl ether and/or hexafluoropropylene. In particular, it is preferably a copolymer containing tetrafluoroethylene and perfluoroalkyl vinyl ether, and the content of perfluoroalkyl vinyl ether is preferably 0.5 to 3.0 mol %.

Such perfluorinated fluororesin (C) is preferable from the viewpoint of improving the film formability of the primer layer.

The perfluorinated fluororesin (C) has a MFR of 5 to 30 (g/10 min). Herein, MFR is a value measured under conditions having a temperature of 372° C. and a load of 5.0 kg in accordance with ASTM D3307 and D2116.

MFR is more preferably 15 to 30 (g/10 min).

The perfluorinated fluororesin (C) preferably has a melting point of 250 to 320° C. Herein, the melting point is a temperature corresponding to the maximum value in the heat of fusion curve when increasing the temperature at a rate of 10° C./min using a differential scanning calorimeter (DSC).

The melting point is more preferably 260 to 310° C.

The perfluorinated fluororesin (C) may be a dispersion or a powder obtained by emulsion polymerization or suspension polymerization or, moreover, may be a fine powder obtained by further performing grinding for pulverization.

When using the perfluorinated fluororesin (C) in the form of a powder, the average particle size is preferably 0.1 to 50 μm. An average particle size of less than 0.1 μm does not allow the fluororesin layer to be very thick, and an average particle size exceeding 50 μm may result in poor smoothness of the coating film obtained by applying the powder coating material composition of the present disclosure. When used in thin coating or the like, a more preferable upper limit of the average particle size is 10 μm. When used in lining or the like having a film thickness exceeding 200 μm, a more preferable lower limit of the average particle size is 1 μm, a more preferable upper limit is 40 μm, and an even more preferable lower limit is 5 μm.

Herein, the average particle size is a value measured by a laser measurement method.

The content of the perfluorinated fluororesin (C) is 50.0 to 95.0% by mass of the total of the amide group-containable polymer compound (A), the polyphenylene sulfide (B), and the perfluorinated fluororesin (C). When the powder coating material composition is used as a primer composition that will be described below, a content of less than 50.0% by mass likely results in poor adhesion between a coating film obtained by applying the primer composition and a fluororesin layer stacked on the coating film, and a content exceeding 95.0% by mass likely results in poor adhesion between the coating film and a coating target that will be described below. A more preferable lower limit is 60% by mass, and a more preferable upper limit is 85% by mass.

The above numerical ranges are of values concerning the solid mass of the perfluorinated fluororesin (C). When preparing the powder coating material composition of the present disclosure, the perfluorinated fluororesin (C) may be added in the form of a liquid material such as a dispersion as described above, and in this case, the solid mass of the perfluorinated fluororesin (C) is a value corresponding to the dry mass of powder obtained by removing particles of the perfluorinated fluororesin (C).

In order to improve the film formability, corrosion resistance, and the like of the coating film obtained from the powder coating material composition, the powder coating material composition of the present disclosure may contain, as necessary, a further resin that has a heat resistance of 200° C. or higher and that is different from any of the amide group-containable polymer compound (A), the polyphenylene sulfide (B), and the perfluorinated fluororesin (C).

The further resin is not limited, examples include polyether sulfone resins, polyether ether ketone resins, and polyether ketone resins, and one of or two or more such resins may be used.

In order to improve coating workability and the properties of the coating film obtained from the powder coating material composition, the powder coating material composition of the present disclosure may contain additives as necessary.

The additives are not limited, and examples include leveling agents, solid lubricants, pigments, glittering agents, fillers, pigment dispersants, anti-settling agents, moisture absorbers, surface conditioners, thixotropic agents, viscosity modifiers, anti-gelling agents, ultraviolet absorbers, light stabilizers, plasticizers, anti-floating agents, anti-skinning agents, anti-scratch agents, antifungal agents, antibacterial agents, anticorrosive agents, antistatic agents, and silane coupling agents.

Herein, the anticorrosive agent means an agent that has the property of not inhibiting the oxidation of an amide group but inhibiting the oxidation of a coating target.

In the powder coating material composition of the present disclosure, when using the amide group-containable polymer compound (A) in a particle form, the average particle size of particles composed of the amide group-containable polymer compound (A) and particles composed of the polyphenylene sulfide (B) is preferably 5 to 100 μm. The average particle size is more preferably 10 to 80 μm.

When using the powder coating material composition of the present disclosure as a powder coating material, a more preferable upper limit of the average particle size of particles composed of the amide group-containable polymer compound (A) and particles composed of the polyphenylene sulfide (B) is 200 μm, and an even more preferable upper limit is 150 μm. The average particle size of particles composed of the perfluorinated fluororesin (C) is preferably 0.1 to 50 μm as described above.

The coating material composition of the present disclosure is of a powder coating material type. The average particle size of the entirety of the powder coating material composition is preferably 10 to 50 μm. An average particle size within the above range is preferable because coatability is stable, and a uniform coating film is obtained. The lower limit of the average particle size is more preferably 15 μm, and the upper limit is more preferably 40 μm. The average particle size can be measured with a laser diffraction/scattering particle size analyzer MT3300EXII manufactured by Nikkiso Co., Ltd.

The coating material composition of the present disclosure preferably has an apparent density of 0.50 to 1.00 (g/mL). An apparent density of less than 0.50 (g/mL) possibly results in poor handleability. An apparent density exceeding 1.00 (g/mL) may adversely affect mass productivity during coating material production. The lower limit of the apparent density is more preferably 0.55 (g/mL), and the upper limit is more preferably 0.90 (g/mL). The apparent density can be measured in accordance with JIS K 6891.

The powder coating material composition of the present disclosure contains the perfluorinated fluororesin (C), and thus a coating film having a two-layer structure and having excellent adhesion to a coating target is usually obtained as described above. Therefore, in the case of providing a coating in which the surface layer is composed of fluororesin, the powder coating material composition may be applied only once by a so-called one-coat method, and, also, the powder coating material composition of the present disclosure may be used as a primer composition, and an overcoating material may be applied to a coating film formed by applying the primer composition.

The powder coating material composition of the present disclosure can be suitably used as a primer composition.

The primer composition is an undercoating material composition that is applied to a coating target prior to applying an overcoating material. Herein, the primer composition may be referred to as a primer. The overcoating material, depending on the applications of a coated article obtained by coating, is preferably a coating material composed of the perfluorinated fluororesin (D) in terms of being capable of imparting usual properties of fluororesin such as corrosion resistance and non-stickiness. Herein, a coating film obtained by applying a coating material composed of the perfluorinated fluororesin (D) as an overcoating material may be referred to as a fluororesin layer. The powder coating material composition of the present disclosure is, in other words, a primer composition, and the primer composition is preferably an undercoating material composition for a fluororesin layer composed of the perfluorinated fluororesin (D). The perfluorinated fluororesin (D) will be described below.

Preferably, the powder coating material composition of the present disclosure is a chromium-free primer not containing hexavalent chromium, which plays the role as a binder component, and a coating film specimen obtained by applying the powder coating material composition to a coating target has a peel adhesion strength of 60 N/cm or more after being left to stand at 350° C. for 20 hours in a heat resistance test and has a peel adhesion strength of 40N/cm or more after being immersed in hot water at 90° C. or higher for 24 hours in a hot water treatment resistance test.

Herein, peel adhesion strength is force required to peel off a test piece in a 90° direction at a tensile rate of 50 mm/min in accordance with JIS K 6854-1 (1999) using a Tensilon universal tester.

The coating film specimen is obtained by applying the powder coating material composition to a coating target. The coating film specimen is a coating film obtained as follows: An iron plate (SS400, length 100 mm×width 50 mm×thickness 1.5 mm, average roughness [Ra]=2 to 3 μm) blast-treated with alumina powder at a spraying pressure of 0.5 MPa is used as the coating target, this iron plate is spray-coated with the powder coating material composition so as to have a dry film thickness of 30 μm and dried at 120° C. for 30 minutes, and then a PFA powder coating material (average particle size: 220 μm, melt flow rate: 6 g/10 min) is placed on the resulting dry film such that the total film thickness after sintering is 1 mm, and is sintered at 350° C. for 1 hour.

Herein, the “chromium-free primer” means a primer in which hexavalent chromium does not play the role of a binder component. Accordingly, even when containing a simple substance of hexavalent chromium or a compound with hexavalent chromium, the chromium-free primer is a primer in which a simple substance of hexavalent chromium or a compound with hexavalent chromium does not play the role of a binder component, and is preferably a primer that does not contain a simple substance of hexavalent chromium or a compound with hexavalent chromium.

The powder coating material composition of the present disclosure is more preferably a chromium-free primer containing no chromium element.

The powder coating material composition of the present disclosure contains the perfluorinated fluororesin (C) and thus plays the role of increasing adhesion to a coating target and, due to the compatibility of fluororesins contained in both the overcoating material and the primer composition, also increasing adhesion to the fluororesin layer. When not containing the perfluorinated fluororesin (C), the powder coating material composition of the present disclosure plays the role of mainly increasing adhesion to a coating target.

Preferably, the powder coating material composition of the present disclosure is a chromium-free primer, preferably a chromium-free primer containing no chromium element, and a coating film specimen obtained by applying the powder coating material composition to a coating target has a peel adhesion strength of 60 N/cm or more after being left to stand at 350° C. for 20 hours in a heat resistance test and has a peel adhesion strength of 40 N/cm or more after being immersed in hot water at 90° C. or higher for 24 hours in a hot water treatment resistance test (hereinafter it may be referred to as a “power coating material composition (Z1)”).

The powder coating material composition (Z1) of the present disclosure is a composition that satisfies the above conditions, and does not necessarily need to be a powder coating material composition composed of the above-described amide group-containable polymer compound (A) and polyphenylene sulfide (B) wherein the polyphenylene sulfide (B) accounts for 1 to 50% by mass of the total of the amide group-containable polymer compound (A) and the polyphenylene sulfide (B) (hereinafter, it may be referred to as a powder coating material composition (Y) of the present disclosure).

As for the powder coating material composition (Z1) of the present disclosure, the coating film specimen has a peel adhesion strength of 60 N/cm or more after being left to stand at 350° C. for 20 hours in a heat resistance test. As for the powder coating material composition (Z1) of the present disclosure, the resulting coating film has excellent heat resistance and can maintain sufficient resistance to long-term use at high temperatures and adhesion to a coating target such that the peel adhesion strength after the heat resistance test is within the above range.

A preferable lower limit of peel adhesion strength after the heat resistance test is 65 N/cm, and a more preferable lower limit is 70 N/cm. The upper limit of peel adhesion strength can be, for example, 200 N/cm as long as it is within the above range.

Herein, peel adhesion strength is force required to peel off a test piece in a 90° direction at a tensile rate of 50 mm/min in accordance with JIS K 6854-1 (1999) using a Tensilon universal tester.

As for the powder coating material composition (Z1) of the present disclosure, the coating film specimen has a peel adhesion strength of 40 N/cm or more after being immersed in hot water at 90° C. or higher for 24 hours in a hot water treatment resistance test. As for the powder coating material composition (Z1) of the present disclosure, the resulting coating film has excellent hot water resistance and can maintain sufficient resistance to long-term use at high temperatures and adhesion to a coating target even in applications where the coating film is used to be in contact with hot water such that the peel adhesion strength after the hot water treatment resistance test is within the above range. A preferable lower limit of peel adhesion strength after the hot water treatment resistance test is 50 N/cm, and a more preferable lower limit is 60 N/cm. The upper limit of peel adhesion strength can be, for example, 200 N/cm as long as it is within the above range.

As for the powder coating material composition (Z1) of the present disclosure, the coating film specimen satisfies both peel adhesion strength after the heat resistance test within the above range and peel adhesion strength after the hot water treatment resistance test within the above range. The powder coating material composition (Z1) of the present disclosure thus has excellent adhesion to a coating target, and adhesion to a coating target is comparable to or even better than conventional chromium phosphate primers.

As for the powder coating material composition (Z1) of the present disclosure, the coating film specimen is obtained by applying the powder coating material composition to a coating target. The coating film specimen is a coating film obtained as follows: An iron plate (SS400, length 100 mm×width 50 mm×thickness 1.5 mm, average roughness [Ra]=2 to 3 μm) blast-treated with alumina powder at a spraying pressure of 0.5 MPa is used as the coating target, this iron plate is spray-coated with the powder coating material composition so as to have a dry film thickness of 30 μm and dried at 120° C. for 30 minutes, and then a PFA powder coating material (average particle size: 220 μm, melt flow rate: 6 g/10 min) is placed on the resulting dry film such that the total film thickness after sintering is 1 mm, and is sintered at 350° C. for 1 hour.

The powder coating material composition (Z1) of the present disclosure can achieve peel adhesion strength that is within the above range irrespective of whether the coating target is a metal that slowly forms an oxide film or a metal that promptly forms an oxide film.

The metal that promptly forms an oxide film may be any metal that likely forms an oxide film to the same extent as stainless steel at least by the sintering during the course of applying the coating material composition of the present disclosure, and, as a coating target, it may already have an oxide film at the time of applying the coating material composition of the present disclosure. The metal that promptly forms an oxide film may be stainless steel or the like.

Herein, the metal that slowly forms an oxide film is a metal that forms an oxide film at a slower rate than stainless steel. The metal that slowly forms an oxide film is different from the metal that promptly forms an oxide film in that the extent of oxide film formability is different. Examples of the metal that slowly forms an oxide film include aluminum and iron.

The powder coating material composition (Z1) of the present disclosure is preferably a powder coating material composition composed of a heat-resistant polymer compound.

The powder coating material composition (Z1) of the present disclosure is more preferably a powder coating material composition composed of the heat-resistant polymer compound and, moreover, the above-described polyphenylene sulfide (B).

The polyphenylene sulfide (B) preferably accounts for 1 to 50% by mass of the total of the heat-resistant polymer compound and the polyphenylene sulfide (B).

When the polyphenylene sulfide (B) is contained, the heat-resistant polymer compound is preferably the amide group-containable polymer compound (A).

The powder coating material composition (Z1) of the present disclosure is more preferably the powder coating material composition (Y) of the present disclosure.

The powder coating material composition of the present disclosure has heat-resisting adhesion that withstands sintering at high temperatures for a long period of time during coating. Although the mechanism by which the powder coating material composition of the present disclosure has heat-resistant adhesion is not clear, it is presumed as follows.

That is to say, it is presumed that, conventionally, deterioration of heat-resisting adhesion observed in a primer layer composed of PAI is due to the oxidative deterioration of an adhesive functional group such as an amide group contained in PAI resulting from sintering at high temperatures for a long period of time. It is presumed that the powder coating material composition of the present disclosure can achieve heat-resisting adhesion comparable to that of chromium phosphate primers by containing the polyphenylene sulfide (B) that suppresses oxidation of an adhesive functional group such as an amide group contained in the amide group-containable polymer compound (A) such as PAI. Due to the perfluorinated fluororesin (C) contained, the powder coating material composition of the present disclosure provides a higher concentration of the perfluorinated fluororesin (C) in a portion farther away from a coating target by a single application, and thus a coating film can be obtained that has excellent adhesion between a layer containing the amide group-containable polymer compound (A) and the polyphenylene sulfide (B) as main components and a layer containing the perfluorinated fluororesin (C) as a main component. It is presumed that the powder coating material composition of the present disclosure can increase heat-resisting adhesion between a coating film composed of the powder coating material composition of the present disclosure and a fluororesin layer because a layer having the perfluorinated fluororesin (C) is obtained on the surface. It is also presumed that the powder coating material composition of the present disclosure, when the perfluorinated fluororesin (C) has an adhesive functional group that will be described below, can further increase heat-resisting adhesion between a coating film composed of the powder coating material composition and a fluororesin layer.

The thickness of a coating film obtained from the powder coating material composition of the present disclosure is preferably 10 to 300 μm. In the present disclosure, the coating material composition is of a powder coating material type, and thus a coating film having a thickness exceeding 100 μm can be suitably obtained.

The fluorine-containing resin laminate of the present disclosure includes a coating target, a coating film, and a fluororesin layer. The coating film is, as described above, obtained by applying the powder coating material composition of the present disclosure and, in the fluorine-containing resin laminate, is obtained by applying the powder coating material composition of the present disclosure to the coating target. In the fluorine-containing resin laminate of the present disclosure, the coating target, the coating film, and the fluororesin layer are stacked in this order.

The coating target is the subject of coating with the powder coating material composition of the present disclosure.

The coating target is not limited, and examples include those made of metals such as aluminum, stainless steel (SUS), and iron; heat-resistant resins; and ceramics, and metals are preferable. The metal may be a simple metal or an alloy and, in terms of good adhesion to the resulting coating film, may be a metal that promptly forms an oxide film such as stainless steel, copper, or copper alloy, or may be a metal that slowly forms an oxide film such as aluminum or iron.

The metal that promptly forms an oxide film readily forms an oxide film on the surface, and it is presumed that this oxide film is the cause of lowered adhesion to the coating film obtained by applying conventional coating material compositions. In the powder coating material composition of the present disclosure, a substance that can suppress not only the oxidation of an amide group but also the oxidation of a coating target is used as the polyphenylene sulfide (B) and, therefore, even when the coating target is composed of a metal that promptly forms an oxide film, sufficient adhesion to the coating film can be obtained.

The coating target is preferably a coating target that has undergone removal of resin components and a surface roughening treatment before receiving the powder coating material composition of the present disclosure from the viewpoint of having improved adhesion to a coating film obtained by applying the powder coating material composition. Examples of the method for removing resin components include a method involving an organic solvent, an alkali, or the like, and a method involving decomposition of resin components at a temperature of 300° C. or higher.

The coating film can be formed on the coating target by applying the powder coating material composition of the present disclosure, optionally drying the powder coating material composition at 80 to 150° C. for 10 to 60 minutes, and then sintering the powder coating material composition.

The method for applying the powder coating material composition is preferably electrostatic coating, fluidized bed coating, or rotolining coating.

As described above, the sintering is usually carried out by heating at a temperature equal to or higher than the melting point of the perfluorinated fluororesin (C) for 10 to 60 minutes although the temperature depends on the melting points of the amide group-containable polymer compound (A), the polyphenylene sulfide (B), and the perfluorinated fluororesin (C) in the powder coating material composition of the present disclosure. When the powder coating material composition of the present disclosure is used as a primer composition, the sintering may be performed before applying an overcoating material or may be performed, not before applying an overcoating material, but simultaneously with the sintering of the overcoating material after applying the overcoating material.

The fluororesin layer is formed on the coating film and is composed of the perfluorinated fluororesin (D).

The powder coating material composition of the present disclosure contains the perfluorinated fluororesin (C), thus the surface of a coating film formed by applying the powder coating material composition to a coating target contains the perfluorinated fluororesin (C) in large amounts, and in order to increase compatibility with and adhesion to the surface of the coating film, the perfluorinated fluororesin (D) in the fluororesin layer to be formed on the coating film is preferably a fluororesin having a composition identical or similar to the perfluorinated fluororesin (C).

In terms of having an increased adhesion to the coating film obtained by applying the powder coating material composition of the present disclosure, the fluororesin layer may contain the perfluorinated fluororesin (C) in addition to the perfluorinated fluororesin (D).

The adhesion between the coating film obtained from the powder coating material composition of the present disclosure and the fluororesin layer can be improved by using a resin composed of a polymer having a terminal functional group as the perfluorinated fluororesin (C).

The terminal functional group is not limited, and examples include —COOR¹ (wherein RI represents a hydrogen atom, an alkyl group having 1 to 5 carbon atoms, or a perfluoroalkyl group having 1 to 3 carbon atoms), —COF, —CONH₂, —CH₂OH, —COOM¹, —SO₄M², —SO₃M³ (wherein M¹, M² and M³ are the same or different and each represent a Group I atom or an atomic group that can become a monovalent cation), —SO₄M⁴_{1/2}, and —SO₃M⁵_{1/2} (wherein M⁴ and M⁵ are the same or different and each represent a Group II atom, a transition metal such as iron, or an atomic group that can become a divalent cation). Examples of the Group I atom include a hydrogen atom, a sodium atom, and a potassium atom, and examples of the atomic group that can become a monovalent cation include an ammonium group. Examples of the Group II atom include calcium and magnesium. Examples of the transition metal include iron.

The amount of the terminal functional group is preferably in the range of 50 to 100,000 per one million carbon atoms in the polymer molecular chain of the perfluorinated fluororesin (C). An amount of less than 50 likely results in poor adhesion, and an amount exceeding 100,000 likely results in intense foaming during sintering and thus coating film defects. A more preferable lower limit is 100 per one million carbon atoms in the polymer molecular chain of the perfluorinated fluororesin (C) and an even more preferable lower limit is 500, and a more preferable upper limit is 50,000 and an even more preferable upper limit is 10,000.

The amount of the terminal functional group is a value obtained by measurement using an infrared spectrophotometer.

The amount of the terminal functional group in the polymer having a terminal functional group can be usually regulated by performing polymerization with a suitably selected catalyst, chain transfer agent, and polymerization conditions.

The amount of the functional group in the polymer having a terminal functional group can be increased by polymerizing the monomer having a functional group.

The polymer of the perfluorinated fluororesin (C) obtained by polymerizing the monomer having a functional group as a monomer is suitably reacted with a reaction reagent such as an acid or an alkali and thermally treated, and thereby the chemical structure of the (terminal) functional group is partially altered due to the action of the reaction reagent and heat.

The fluorine-containing resin laminate of the present disclosure can be obtained by applying an overcoating material composed of the perfluorinated fluororesin (D) to a coating film obtained by applying the powder coating material composition of the present disclosure and sintering the overcoating material for 30 to 120 minutes at a temperature equal to or higher than the melting point of the perfluorinated fluororesin (D).

As with the powder coating material composition of the present disclosure, the type of the overcoating material containing the perfluoro-based fluororesin (D), i.e., a powder coating material or a liquid coating material, is selectively used according to the desired film thickness, and from the viewpoint of corrosion resistance (from the viewpoint of an increased film thickness), a powder coating material is preferably used. The same dispersion medium, dispersing agent, additive, further resins, and the like as those used in the powder coating material composition of the present disclosure can be used in the overcoating material containing the perfluorinated fluororesin (D).

The fluororesin layer preferably has a film thickness of 200 μm or more.

The powder coating material composition of the present disclosure, even when the thickness of the fluororesin layer is 200 μm or more, can maintain sufficient adhesion, and is particularly useful for lining processing that requires long-term sintering at high temperatures.

Applications of the fluorine-containing resin laminate of the present disclosure are not limited, and examples include coating material applications for various electric wires such as heat-resistant enameled wires in terms of having superior resistance to processing deterioration compared with conventional PAI enameled wires; electrical/electronic industry related applications such as information equipment parts (paper separation pawls, printer guides, gears, bearings), connectors, burn-in sockets, IC sockets, electrical parts for oil fields, relays, electromagnetic wave shields, relay cases, switches, covers, and terminal board buses; machinery industry related applications such as valve seats, seals for hydraulics, backup rings, piston rings, wear bands, vanes, ball bearing retainers, rollers, cams, gears, bearings, labyrinth seals, pump parts, mechanical linkages, bushings, fasteners, spline liners, brackets, hydraulic pistons, chemical pump casings, valves, valves, tower packings, coil bobbins, packings, connectors, gaskets, and valve seals; vehicle industry related applications such as thrust washers, seal rings, gears, bearings, tappets, engine parts (pistons, piston rings, valve stays), transmission parts (spool valves, ball check valves, sealants) and rocker arms; and aerospace industry related applications such as jet engine parts (bushings, washers, spacers, nuts), power control clutches, door hinge bearings, connectors, tube clamps, brackets, hydraulic parts, antennae, radomes, frames, fuel system parts, compressor parts, rocket engine parts, wear strips, connector shelves, and space structures. Further examples of applications include pin covers for canning machines, parts for plating equipment, nuclear power related parts, ultrasonic transducers, potentiometer shafts, and hydrant parts.

In addition to the above various applications, the applications of the fluorine-containing resin laminate according to the present invention include corrosion resistance applications such as mixer blades, tank inner surfaces, vessels, towers, centrifugal separators, pumps, valves, pipes, heat exchangers, plating jigs, tank inner surfaces of tank trucks, and screw conveyors; semiconductor related applications such as ducts of semiconductor factories; industrial mold release applications such as rolls for office automation, belts for office automation, papermaking rolls, calendering rolls for film production, and injection molds; household electrical appliance and kitchen appliance related applications such as rice cookers, pots, hot plates, irons, frying pans, bread makers, bread baking trays, tops of gas cookers, bread baking sheets, skillets, and kettles; and industrial part related applications such as sliding members of precision mechanisms including various gears, papermaking rolls, calendering rolls, mold releasing parts, casings, valves, valves, packing, coil bobbins, oil seals, joints, antenna caps, connectors, gaskets, valve seals, anchor bolts, and anchor nuts.

The method for producing a formed article using the fluorine-containing resin laminate of the present disclosure is not limited and may be, for example, injection molding, and by machining a formed article once obtained, a formed article having a desired shape can also be obtained.

Applications of a formed article obtained using the fluorine-containing resin laminate of the present disclosure are not limited, and examples include applications described above for the fluorine-containing resin laminate of the present disclosure.

### EXAMPLES

Below, the present disclosure will now be specifically described by way of Examples.

In the following Examples, “parts” and “%” mean “parts by mass” and “% by mass”, respectively, unless specified otherwise.

### Example 1

First, 120 g of polyamideimide (PAI) resin powder, 80 g of polyphenylene sulfide (PPS) resin powder, and 800 g of PFA powder A (tetrafluoroethylene/perfluoropropyl vinyl ether=98.0/2.0 (mol), MFR: 20 g/10 min, melting point: 301° C., average particle size: 20 μm) were dispersed using a stirrer (FM mixer manufactured by Nippon Coke & Engineering Co., Ltd.), and thus a powder coating material composition A was obtained.

To an iron plate (SS400, surface roughness Ra: 2 to 3 μm) blasted with alumina powder (manufactured by Ujiden Chemical Industry Co., Ltd., Tosa Emery #40) at a spray pressure of 1.0 MPa was electrostatically applied the powder coating material composition A so as to have a film thickness after being sintered of 50 μm, and was sintered at 380° C. for 30 minutes. PFA powder (MFR: 6 g/10 min, average particle size: 200 μm) was placed on the resulting film so as to have a total film thickness after being sintered of 1,000 μm, and was sintered at 350° C. for 60 minutes, and thus a fluorine-containing resin laminate A having a fluorine-containing resin film was obtained. This fluorine-containing resin laminate A was subjected to the following evaluations.

Heat resistance evaluation: A cut was made to a width of 10 mm in the fluorine-containing resin coating film, then the film was heated in an electric furnace at 350° C. for 20 hours and returned to room temperature, and then peel strength was measured in a 90° direction relative to the test piece at a tensile rate of 50 mm/min using a Tensilon universal tester in accordance with JIS K 6854-1. Note that, when the fluorine-containing resin film was already peeled off after being heated for 20 hours, peel strength was defined as 0 N/cm.

Hot-water resistance evaluation: A cut was made to a width of 10 mm in the fluorine-containing resin coating film, then the film was immersed in hot water at 90° C. for 24 hours and returned to room temperature, and then peel strength was measured in the same manner as the above heat resistance evaluation. Note that, when the fluorine-containing resin film was already peeled off after being immersed for 24 hours, peel strength was defined as 0 N/cm.

### Example 2

The heat resistance evaluation and the hot water resistance evaluation were conducted in the same manner as in Example 1 except that FEP powder A (tetrafluoroethylene/hexafluoropropylene=90.0/10.0 (mol), MFR: 6 g/10 min, melting point: 270° C., average particle size: 40 μm) was used in place of PFA powder A.

### Example 3

The heat resistance evaluation and the hot water resistance evaluation were conducted in the same manner as in Example 1 except that FEP powder B (tetrafluoroethylene/hexafluoropropylene/perfluoropropyl vinyl ether=88.5/10.5/1.0 (mol), MFR: 20 g/10 min, melting point: 258° C., average particle size: 30 μm) was used in place of PFA powder A.

### Comparative Example 1

The heat resistance evaluation and the hot water resistance evaluation were conducted in the same manner as in Example 1 except that PFA powder B (tetrafluoroethylene/perfluoropropyl vinyl ether=98.5/1.5 (mol), MFR: 2 g/10 min, melting point: 304° C., average particle size: 40 μm) was used in place of PFA powder A.

### Comparative Example 2

The heat resistance evaluation and the hot water resistance evaluation were conducted in the same manner as in Example 1 except that PFA powder C (tetrafluoroethylene/perfluoroalkyl vinyl ether=98.0/2.0 (mol), MFR: 40 g/10 min, melting point: 296° C., average particle size: 30 μm) was used in place of PFA powder A.

### Comparative Example 3

The heat resistance evaluation and the hot water resistance evaluation were conducted in the same manner as in Example 1 except that FEP powder C (tetrafluoroethylene/hexafluoropropylene=89.0/11.0 (mol), MFR: 1 g/10 min, melting point: 272° C., average particle size: 40 μm) was used in place of PFA powder A.

TABLE 1

| | Example | Example | Example | Comparative | Comparative | Comparative |
|---|---|---|---|---|---|---|
| | 1 | 2 | 3 | Example 1 | Example 2 | Example 3 |
| PAI | 120 | 120 | 120 | 120 | 120 | 120 |
| PPS | 80 | 80 | 80 | 80 | 80 | 80 |
| PFA powder A | 800 | — | — | — | — | — |
| (MFR: 20 (g/10 min)) | | | | | | |
| PFA powder B | — | — | — | 800 | — | — |
| (MFR: 2 (g/10 min)) | | | | | | |
| PFA powder C | — | — | — | — | 800 | — |
| (MFR: 40 (g/10 min)) | | | | | | |
| FEP powder A | — | 800 | — | — | — | — |
| (MFR: 6 (g/10 min)) | | | | | | |
| FEP powder B | — | — | 800 | — | — | — |
| (MFR: 20 (g/10 min)) | | | | | | |
| FEP powder C | — | — | — | — | — | 800 |
| (MFR: 1 (g/10 min)) | | | | | | |
| Average particle size (μm) | 24.5 | 31.3 | 28.7 | 26.6 | 28.9 | 33.2 |
| Apparent density(g/mL) | 0.64 | 0.67 | 0.71 | 0.60 | 0.71 | 0.58 |
| Peel strength after heat | 75 | 70 | 73 | 55 | 52 | 56 |
| resistance evaluation | | | | | | |
| (N/cm) | | | | | | |
| Peel strength after hot | 68 | 65 | 60 | 31 | 35 | 20 |
| water resistance | | | | | | |
| evaluation | | | | | | |
| (N/cm) | | | | | | |

The results in Table 1 show that the fluorine-containing resin laminates obtained in the Examples have sufficient peel strength in the heat resistance evaluation and the hot water resistance evaluation.

### INDUSTRIAL APPLICABILITY

The powder coating material composition of the present disclosure is a coating material composition capable of forming a coating film that simultaneously has adhesion to a coating target and adhesion to a fluororesin layer, and can be suitably used as a primer for the fluororesin layer.

1. A powder coating material composition comprising an amide group-containable polymer compound (A) that has an amide group or will have an amide group, polyphenylene sulfide (B), and a perfluorinated fluororesin (C), wherein
the amide group-containable polymer compound (A) is an amide group-containing polymer (a1) having an amide group and an aromatic ring and/or an amide group-containing polymer precursor (a2) that changes to the amide group-containing polymer (a1) in a sintering step when forming the powder coating material composition into a film,
a content of the polyphenylene sulfide (B) is 1 to 50% by mass of a total of the amide group-containable polymer compound (A) and the polyphenylene sulfide (B),
the perfluorinated fluororesin (C) comprises tetrafluoroethylene in a range of 85.0 to 99.5 mol % and has a melt flow rate (MFR) in a range of 5 to 30 (g/10 min), and
a content of the perfluorinated fluororesin (C) is 50.0 to 95.0% by mass of a total of the amide group-containable polymer compound (A), the polyphenylene sulfide (B), and the perfluorinated fluororesin (C).

2. The powder coating material composition according to claim 1, which has an average particle size of 10 to 50 μm and an apparent density of 0.50 to 1.00 (g/mL).

3. The powder coating material composition according to claim 1, which is an undercoating material composition for a fluororesin layer comprising a perfluorinated fluororesin (D).

4. The powder coating material composition according to claim 1, wherein the perfluorinated fluororesin (C) is a copolymer comprising tetrafluoroethylene and perfluoroalkyl vinyl ether and has a perfluoroalkyl vinyl ether content of 0.5 to 3.0 mol %.

5. The powder coating material composition according to claim 1, wherein the perfluorinated fluororesin (C) has a melting point of 250 to 320° C.

6. A coating film obtained from the powder coating material composition according to claim 1.

7. A fluorine-containing resin laminate comprising a coating target, the coating film according to claim 6, and a fluororesin layer comprising a perfluorinated fluororesin (D), wherein the coating target, the coating film, and the fluororesin layer are stacked in this order.

8. The fluorine-containing resin laminate according to claim 7, wherein the fluororesin layer comprising the perfluorinated fluororesin (D) has a film thickness of 200 μm or more.

9. An article comprising the fluorine-containing resin laminate according to claim 7.
